(19) United States
(12) Patent Application Publication
(10) Pub. No.: US 2014/0226311 A1
(43) Pub. Date: Aug. 14, 2014

(54) LIGHT EMITTING DEVICE AND DISPLAY DEVICE

(71) Applicants: Yasuhiro Ono, Osaka-shi (JP); Makoto Masuda, Osaka-shi (JP); Kenzo Ohkubo, Osaka-shi (JP); Nobuhiro Shirai, Osaka-shi (JP); Takasumi Wada, Osaka-shi (JP)

(72) Inventors: Yasuhiro Ono, Osaka-shi (JP); Makoto Masuda, Osaka-shi (JP); Kenzo Ohkubo, Osaka-shi (JP); Nobuhiro Shirai, Osaka-shi (JP); Takasumi Wada, Osaka-shi (JP)

(73) Assignee: SHARP KABUSHIKI KAISHA, Osaka-shi, Osaka (JP)

(21) Appl. No.: 14/130,192

(22) PCT Filed: May 22, 2012
(86) PCT No.: PCT/JP2012/063052

§ 371 Date: Feb. 21, 2014

(30) Foreign Application Priority Data
Jul. 6, 2011 (JP) 2011-150473

(51) Int. Cl. F21V 7/04

(52) U.S. Cl. CPC F21V 7/04
USPC 362/97.1; 362/296.05

(57) ABSTRACT

There are provided a light-emitting device for use in a backlight unit of a display apparatus equipped with a display panel, which can be made lower in profile and is capable of applying light to the display panel with uniformity in the brightness of the display panel in the planar direction of the display panel, as well as a display apparatus equipped with the light-emitting device. A backlight unit includes a printed substrate, a plurality of light-emitting sections each having a base support, an LED chip and a lens, and a reflective member surrounding the light-emitting section. A specular reflection portion is formed in a first reflective region of the reflective member.

### TECHNICAL FIELD

The present invention relates to a light-emitting device which is provided in a backlight unit for applying light to a back side of a display panel, and a display apparatus equipped with the light-emitting device.

### BACKGROUND ART

In a display panel, a liquid crystal is sealed in between two transparent substrates, and, upon application of voltage, the orientations of liquid crystal molecules are changed with consequent variations in light transmittance, thereby permitting the display of a predetermined image or the like in an optical manner. In the display panel, the liquid crystal is not a light emitter in itself, wherefore, for example, the display panel of a transmissive type has, at its back side, a backlight unit for light irradiation using a light source such as a cold-cathode fluorescent lamp (CCFL) or a light-emitting diode (LED).

Backlight units are classified into two categories, namely a direct-lighting type in which light sources such as cold-cathode fluorescent lamps or LEDs are arranged at the bottom for light emission, and an edge-lighting type in which light sources such as cold-cathode fluorescent lamps or LEDs are arranged at an edge portion of a transparent plate called a light guide plate, so that light can be directed forward, through printed dots or patterns formed at the back, from the edge of the light guide plate.

Although the LED has excellent characteristics, including lower power consumption, longer service life, and the capability of reduction in environmental burdens without the use of mercury, its use as a light source for a backlight unit has fallen behind because of its expensiveness, the fact that there had been no white-color LED prior to the invention of a blue-color LED, and its high directivity. However, in recent years, as white-color LEDs exhibiting high color rendition and high brightness spring into wide use for illumination application purposes, LEDs are becoming less expensive, and consequently, as a light source for a backlight unit, the shift from the cold-cathode fluorescent lamp to the LED has picked up momentum.

LEDs have high directivity, wherefore a backlight unit of edge-lighting type has the advantage over a backlight unit of direct-lighting type from the standpoint of effecting light irradiation in a manner such that a display panel can exhibit uniform surface brightness in a planar direction. However, the edge-lighting type backlight unit poses the following problems: localized arrangement of light sources at the edge portion of the light guide plate results in concentration of heat generated by the light sources; and the size of the bezel portion of the display panel is inevitably increased. Furthermore, the edge-lighting type backlight unit is subjected to severe restrictions in terms of local dimming control which attracts attention as a control technique capable of display of high-quality images and energy saving, and is therefore incapable of split-region control that achieves production of high-quality displayed images and low power consumption as well.

In view of the foregoing, studies are going on to come up with a method whereby, even if a highly-directive LED is used as a light source in a direct-lighting type backlight unit having an advantage in its suitability for local dimming control, light can be applied to a display panel in manner such that the brightness of an object to be illuminated is rendered uniform in the planar direction of the to-be-illuminated object.

For example, in Patent Literature 1, there is disclosed an inverted cone-shaped light-emitting lamp including a light-emitting element, a resin lens having an inverted cone-shaped recess disposed so as to cover the light-emitting element, and a reflective plate disposed around the resin lens. Moreover, in Patent Literature 2, there is disclosed a light-source unit including a light-emitting element and a light-guide reflective body for guiding light emitted from the light-emitting element while reflecting the light in a direction perpendicular to an optical axis.

### CITATION LIST

### Patent Literature

Patent Literature 1: Japanese Unexamined Patent Publication JP-A 61-127186 (1986)
Patent Literature 2: Japanese Unexamined Patent Publication JP-A 2010-238420

### SUMMARY OF INVENTION

### Technical Problem

According to the technologies as disclosed in Patent Literatures 1 and 2, light having high directional property emitted from a light-emitting element is diffused in a direction intersected by the optical axis of the light-emitting element, so that a display panel can be irradiated with the light in the planar direction thereof.

In keeping with the recent increasing demand for a display apparatus of even lower profile, a light-emitting device of direct-lighting type that is to be mounted in such a slimmed-down display apparatus is required to have the capability of allowing light emitted from a light-emitting element to diffuse in a direction intersected by the optical axis of the light-emitting element with high accuracy. However, the technologies as disclosed in Patent Literatures 1 and 2 cannot fully satisfy the above requirement.

For example, in the technology disclosed in Patent Literature 2, the light-emitting element is disposed in the center of the bottom of the reflective plate, and the reflective plate has a quadrangular outer shape, and also the side wall of the reflective plate is disposed perpendicularly with respect to the bottom of the reflective plate. In such a case where the reflective plate has a polygonal outer shape, the distance from the light-emitting element to a corner of the polygonal shape is longer than the distance from the light-emitting element to a side thereof, with the consequence that the quantity of light applied to a part of the display panel which faces the corner is smaller than the quantity of light applied to a part of the display panel which faces the side, which leads to unevenness in the quantity of light applied to the display panel.

An object of the invention is to provide a light-emitting device for use in a backlight unit of a display apparatus equipped with a display panel, which can be made lower in profile and is capable of applying light to the display panel with uniformity in the brightness of the display panel in the planar direction of the display panel, as well as to provide a display apparatus equipped with the light-emitting device.

### Solution to Problem

The invention provides a light-emitting device for illuminating an object to be illuminated, comprising:

a light-emitting section which applies light to a to-be-illuminated object; and

a reflective member disposed around the light-emitting section,

the reflective member being polygonal in outer shape as viewed in a plan view from a to-be-illuminated object side, the reflective member having a specular reflection portion in respective first reflective regions which are regions between corner parts of the reflective member and the light-emitting section as viewed in a plan view from the to-be-illuminated object side,

the light-emitting section being located in a center of the reflective member as viewed in a plan view from the to-be-illuminated object side.

Moreover, in the invention, it is preferable that the reflective member has, in the respective first reflective regions, a first diffuse reflection portion which is lower in specular reflectivity than the specular reflection portion.

Moreover, in the invention, it is preferable that the reflective member has, in respective second reflective regions thereof which are regions between sides of the reflective member and the light-emitting section as viewed in a plan view from the to-be-illuminated object side, a second diffuse reflection portion which is lower in specular reflectivity than the specular reflection portion.

Moreover, in the invention, it is preferable that a total reflectivity of the specular reflection portion is greater than or equal to a total reflectivity of the second diffuse reflection portion.

Moreover, in the invention, it is preferable that a plurality of the specular reflection portions are disposed in the respective first reflective regions so as to be apart from each other.

Moreover, in the invention, it is preferable that the specular reflection portion is formed in a circular shape as viewed in a plan view from the to-be-illuminated object side.

Moreover, in the invention, it is preferable that the specular reflection portion is formed in a strip-like shape extending from the light-emitting section to the corner part as viewed in a plan view from the to-be-illuminated object side.

Moreover, in the invention, it is preferable that the specular reflection portion is formed of silver or aluminum.

Moreover, the invention provides a display apparatus comprising:

a display panel; and

an illuminating apparatus including the light-emitting device which applies light to a back side of the display panel.

### Advantageous Effects of Invention

According to the invention, the specular reflection portion is formed in the respective first reflective regions of the reflective member, wherefore the quantity of light reaching a part of the to-be-illuminated object opposed to the corner part of the reflective member is increased. This makes it possible to render light applied to the to-be-illuminated object uniform.

According to the invention, the quantity of light reaching a part of the to-be-illuminated object opposed to the first reflective region can be maintained at an adequate level by diffuse reflection occurring in the first diffuse reflection portion, wherefore light applied to the to-be-illuminated object can be rendered even more uniform.

According to the invention, the quantity of light reaching the part of the to-be-illuminated object opposed to the corner part of the reflective member can be increased by diffuse reflection occurring in the second diffuse reflection portion. This makes it possible to render light applied to the to-be-illuminated object even more uniform.

According to the invention, the specular reflection portion has a total reflectivity greater than or equal to the total reflectivity of the second diffuse reflection portion, and is therefore less prone to transmission and absorption of light emitted from the light-emitting element. This makes it possible to increase the quantity of light reaching the part of the to-be-illuminated object opposed to the corner part of the reflective member, and thereby render light applied to the to-be-illuminated object even more uniform.

According to the invention, diffuse reflection takes place in a region between the specular reflection portions, wherefore light applied to the part of the to-be-illuminated object opposed to the first reflective region can be rendered uniform.

According to the invention, the number of regions among the specular reflection portions is increased, wherefore light applied to the part of the to-be-illuminated object opposed to the first reflective region can be rendered even more uniform.

According to the invention, the specular reflection portion can be formed in a strip-like shape extending from the light-emitting section to the corner part of the of the reflective member.

According to the invention, by forming the specular reflection portion of silver or aluminum, it is possible to improve dissipation of heat generated from the light-emitting element.

According to the invention, the display apparatus is configured to apply light to the back side of the display panel by means of the illuminating apparatus including the light-emitting device, and is therefore capable of displaying images of even higher quality.

### BRIEF DESCRIPTION OF DRAWINGS

Other and further objects, features, and advantages of the invention will be more explicit from the following detailed description taken with reference to the drawings wherein:

FIG. 1 is an exploded perspective view showing the structure of a liquid-crystal display apparatus;

FIG. 2A is a view schematically showing the section of the liquid-crystal display apparatus taken along the line A-A of FIG. 1;

FIG. 2B is a view schematically showing the section of the liquid-crystal display apparatus taken along the line B-B of FIG. 1;

FIG. 3A is a view showing the positional relationship between an LED chip supported by a base support and a lens;

FIG. 3B is a view showing the base support and the LED chip;

FIG. 3C is a view showing the base support and the LED chip;

FIG. 3D is a view showing the base support and the LED chip;

FIG. 3E is a view showing the LED chip and the base support which are mounted on the printed substrate;

FIG. 4 is a view for explaining an optical path of light emitted from the LED chip;

FIG. 5 is a perspective view of a reflective member and the lens;

FIG. 6 is a view showing the reflective member and the lens as viewed in a plan view in an X direction;

FIG. 7 is a view for explaining an optical path of light emitted from the LED chip;

FIG. 8A is a view showing the reflective member having circular specular reflection portions and the lens as viewed in a plan view in the X direction; and

FIG. 8B is a view showing the reflective member having circular specular reflection portions and the lens as viewed in a plan view in the X direction.

### DESCRIPTION OF EMBODIMENTS

Hereinafter, preferred embodiments of the invention will be described in detail with reference to the drawings.

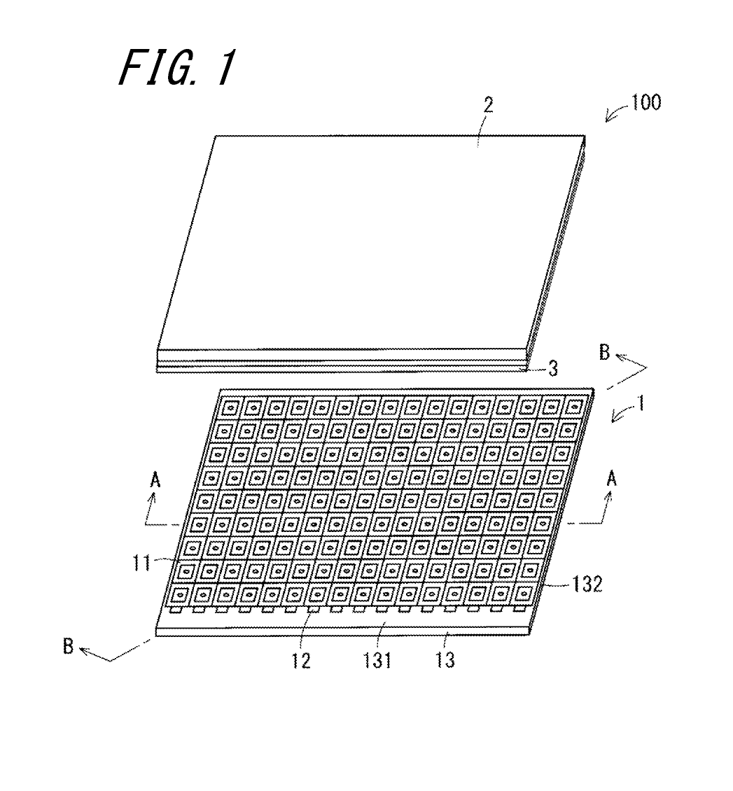

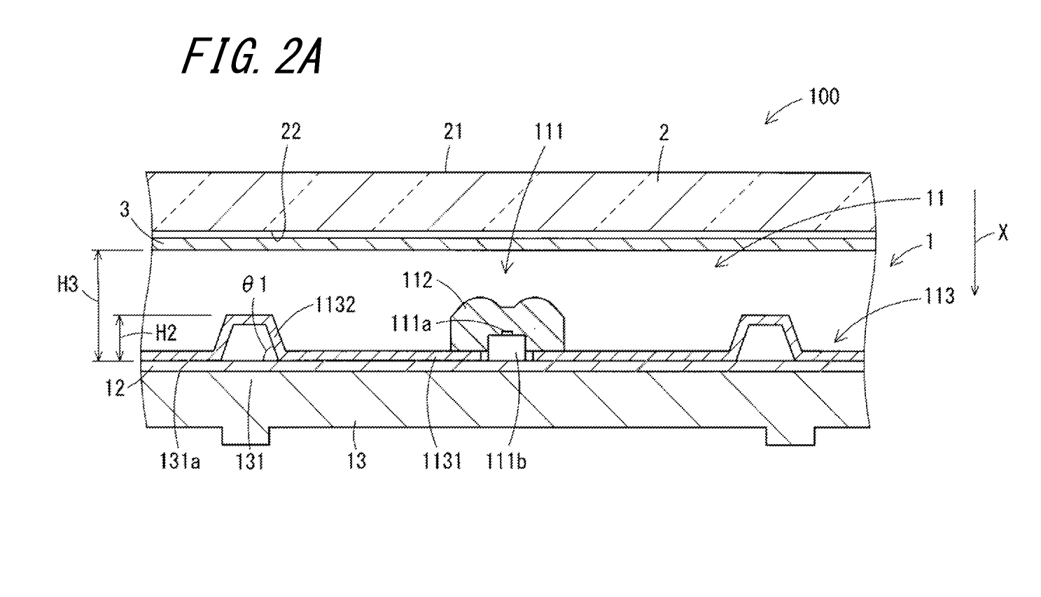

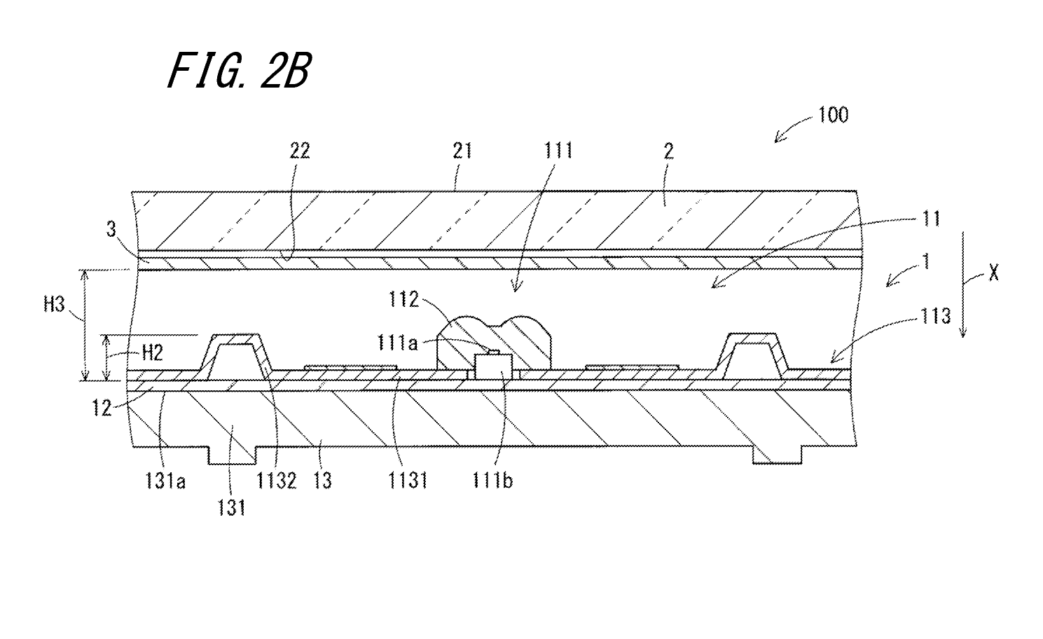

FIG. 1 is an exploded perspective view showing the structure of a liquid-crystal display apparatus 100 in accordance with an embodiment of the invention. FIG. 2A is a view schematically showing the section of the liquid-crystal display apparatus 100 taken along the line A-A of FIG. 1. FIG. 2B is a view schematically showing the section of the liquid-crystal display apparatus 100 taken along the line B-B of FIG. 1. The liquid-crystal display apparatus 100 which is a display apparatus according to the invention is designed for use in television sets, personal computers, and so forth, for showing an image on a display screen in response to output of image information. The display screen is constructed of a liquid-crystal panel 2 which is a transmissive display panel having liquid-crystal elements, and the liquid-crystal panel 2 has the form of a rectangular flat plate. In the liquid-crystal panel 2, two sides in a thickness-wise direction thereof will be referred to as a front side 21 and a back side 22, respectively. The liquid-crystal display apparatus 100 shows an image in a manner such that the image is viewable in a direction from the front side 21 to the back side 22.

The liquid-crystal display apparatus 100 comprises the liquid-crystal panel 2 and a backlight unit 1 including a light-emitting device pursuant to the invention. The liquid-crystal panel 2 is supported on a sidewall portion 132 in parallel to a bottom surface 131a of a bottom portion 131 of a frame member 13 provided in the backlight unit 1. The liquid-crystal panel 2 includes two substrates, and is shaped like a rectangular plate when viewed in the thickness-wise direction. The liquid-crystal panel 2 includes a switching element such as a TFT (thin film transistor), and liquid crystal is filled in a gap between the two substrates. The liquid-crystal panel 2 performs a display function through irradiation of light from the backlight unit 1 placed on the back side 22 as backlight. The two substrates are provided with a driver (source driver) used for pixel driving control in the liquid-crystal panel 2, and various elements and wiring lines.

Moreover, in the liquid-crystal display apparatus 100, a diffusion plate 3 is disposed between the liquid-crystal panel 2 and the backlight unit 1 in parallel to the liquid-crystal panel 2. A prism sheet may be interposed between the liquid-crystal panel 2 and the diffusion plate 3.

The diffusion plate 3 diffuses light emitted from the backlight unit 1 in the planar direction to prevent localized brightness variations. The prism sheet controls a traveling direction of light that has reached there from the back side 22 through the diffusion plate 3 so that the light can be directed toward the front side 21. In the diffusion plate 3, to prevent lack of uniformity in brightness in the planar direction, the traveling direction of light involves, as vector components, many planar-directional components. On the other hand, in the prism sheet, the traveling direction of light involving many planar-directional vector components is converted into a traveling direction of light involving many thickness-directional components. Specifically, the prism sheet is formed by arranging a large number of lenses or prism-like portions in the planar direction, and this arrangement allows reduction in the degree of diffusion of light traveling in the thickness-wise direction. This makes it possible to enhance the brightness of the display in the liquid-crystal display apparatus 100.

The backlight unit 1 is a backlight device of direct-lighting type for applying light to the liquid-crystal panel 2 from the back side 22. The backlight unit 1 includes a plurality of light-emitting devices 11 for applying light to the liquid-crystal panel 2, a plurality of printed substrates 12, and the frame member 13.

The frame member 13 serves as a basic structure of the backlight unit 1, and comprises the flat plate-shaped bottom portion 131 opposed to the liquid-crystal panel 2, with a predetermined spacing secured between them, and the sidewall portion 132 which is continuous with the bottom portion 131 so as to extend upright therefrom. The bottom portion 131 is rectangular-shaped when viewed in the thickness-wise direction, and its size is slightly larger than the size of the liquid-crystal panel 2. The sidewall portion 132 is formed so as to extend upright toward the front side 21 of the liquid-crystal panel 2 from each of two ends corresponding to the short sides of the bottom portion 131 and another two ends corresponding to the long sides thereof. Thus, four flat plate-shaped sidewall portions 132 are formed along the periphery of the bottom portion 131.

The printed substrate 12 is fixed to the bottom portion 131 of the frame member 13. On the printed substrate 12 are arranged a plurality of light-emitting devices 11. The printed substrate 12 is, for example, a glass epoxy-made substrate having an electrically-conductive layer formed on each side.

A plurality of light-emitting devices 11 are intended to apply light to the liquid-crystal panel 2. In this embodiment, the plurality of light-emitting devices 11 are arranged in a group, and, a plurality of printed substrates 12 each having the plurality of light-emitting devices 11 are juxtaposed so as to face the entire area of the back side 22 of the liquid-crystal panel 2, with the diffusion plate 3 lying between them, thereby providing matrix arrangement of the light-emitting devices 11. Each of the light-emitting devices 11, which is square-shaped when viewed in a plan view in an X direction perpendicular to the bottom portion 131 of the frame member 13, is designed so that the brightness of the liquid-crystal panel 2-sided surface of the diffusion plate 3 stands at 6000 cd/m², and the length of a side of the square shape is set at 40 mm, for example.

Each of the plurality of light-emitting devices 11 comprises a light-emitting section 111, and a reflective member 113 placed around the light-emitting section 111 on the printed substrate 12. The light-emitting section 111 includes a light-emitting diode (LED) chip 111a which is a light-emitting element, a base support 111b for supporting the LED chip 111a, and a lens 112 which is an optical member.

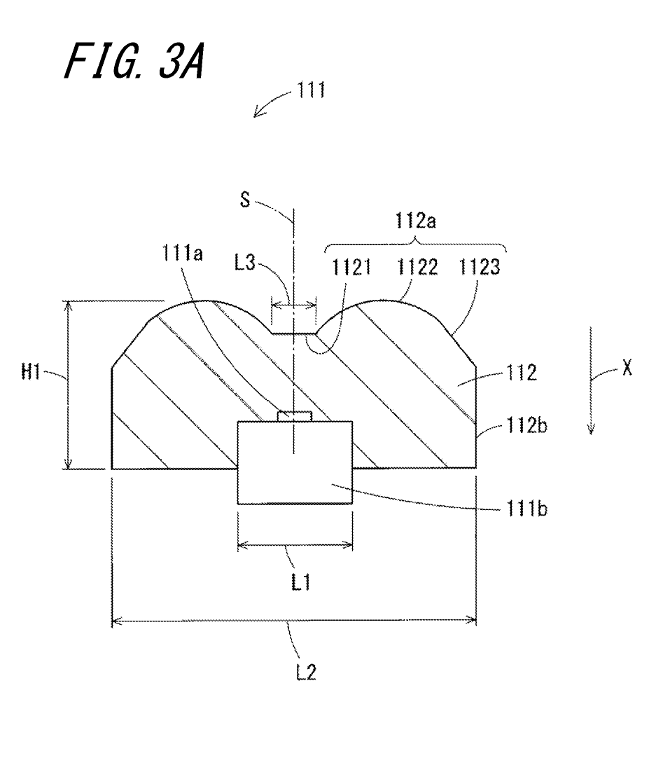

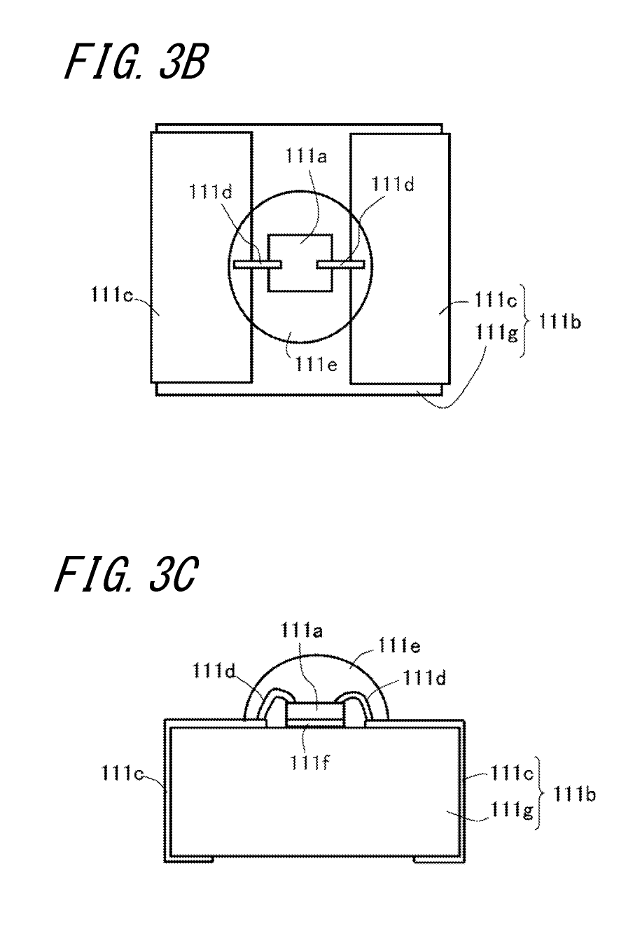

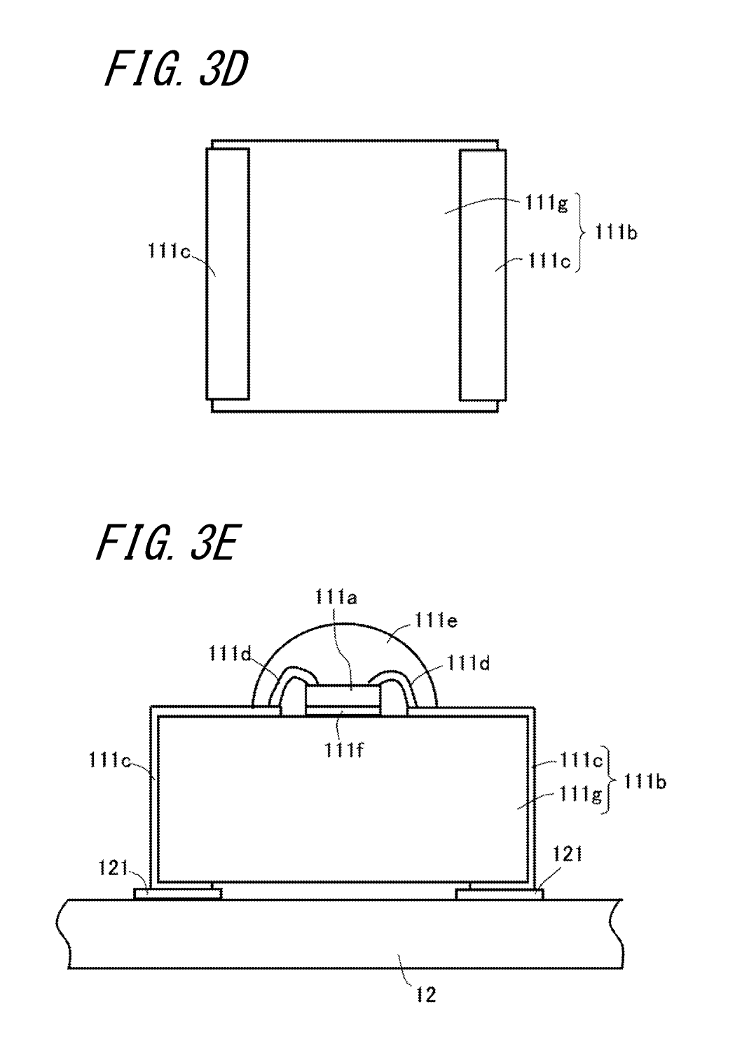

FIG. 3A is a view showing the positional relationship between the LED chip 111a supported by the base support 111b and the lens 112.

The base support 111b is a member for supporting the LED chip 111a. In the base support 111b, its support surface for supporting the LED chip 111a is square-shaped when viewed in a plan view in the X direction, and a length L1 of a side of the square shape is set at 3 mm, for example. Moreover, the height of the base support 111b is set at 1 mm, for example.

FIGS. 3B to 3D are views showing the base support 111b and the LED chip 111a, of which FIG. 3B is a plan view, FIG. 3C is a front view, and FIG. 3D is a bottom view. As shown in FIGS. 3B to 3D, the base support 111b includes a base main body 111g made of ceramics, and two electrodes 111c disposed on the base main body 111g, and, the LED chip 111a is secured to a center of the top surface of the base main body 111g serving as the support surface of the base support 111b by a bonding member 111f. The two electrodes 111c, which are spaced apart from each other, each extend over the top surface, side surface, and bottom surface of the base main body 111g.

Two terminals (not shown) of the LED chip 111a are connected to the two electrodes 111c by two bonding wires 111d, respectively. The LED chip 111a and the bonding wire 111d are sealed with a transparent resin 111e such as silicon resin.

FIG. 3E shows the LED chip 111a and the base support 111b which are mounted on the printed substrate 12. The LED chip 111a is mounted on the printed substrate 12, with the base support 111b lying between them, for emitting light in a direction away from the printed substrate 12. When the light-emitting device 11 is viewed in a plan view in the X direction, the LED chip 111a is located in a center of the base support 111b. In the plurality of light-emitting devices 11, their LED chips 111a can be controlled on an individual basis in respect of light emission. This allows the backlight unit 1 to perform local dimming control.

When mounting LED chip 111a and the base support 111b on the printed substrate 12, solder is applied onto each of two connection terminal portions 121 of an electrically-conductive layer pattern provided in the printed substrate 12, and the base support 111b and the LED chip 111a fixed to the base support 111b are placed on the printed substrate 12 so that the two electrodes 111c disposed on the bottom surface of the base main body 111g can be brought into registry with their respective solders by an automated machine (not shown), for example. The printed substrate 12 bearing the base support 111b and the LED chip 111a fixed to the base support 111b is delivered to a reflow bath for infrared radiation, and the solder is heated to a temperature of about 260° C., whereby the base support 111b is soldered to the printed substrate 12.

The lens 112, which is disposed in contact with the LED chip 111a so as to cover the base support 111b supporting the LED chip 111a by means of insert molding, allows light emitted from the LED chip 111a to undergo reflection or refraction in a plurality of directions. That is, the lens effects light diffusion. The lens 112 is a transparent lens made for example of silicon resin or acrylic resin.

The lens 112 is substantially cylindrically shaped, with its top surface 112a facing the liquid-crystal panel 2 curved so as to provide a recess in a center thereof, and with its side surface 112b kept in parallel with an optical axis S of the LED chip 111a, and a diameter L2 of its section perpendicular to the optical axis S is set at 10 mm, for example, and also, the lens 112 extends outward relative to the base support 111b. That is, the lens 112 is larger than the base support 111b with respect to a direction perpendicular to the optical axis S of the LED chip 111a (the diameter L2 of the lens 112 is greater than the length L1 of one side of the support surface of the base support 111b). Thus, where the lens 112 extends outward relative to the base support 111b, light emitted from the LED chip 111a can be diffused over an even broader range by the lens 112.

Moreover, a height H1 of the lens 112 is set at 4.5 mm, for example, which is smaller than the diameter L2. In other words, the lens 112 is so configured that its length in a direction perpendicular to the optical axis S of the LED chip 111a (the diameter L2) is greater than the height H1. Light incident on the lens 112 is diffused in a direction intersected by the optical axis S in the interior of the lens 112.

The reason why the diameter L2 is set to be greater than the height H1 as described above is to make the backlight unit 1 lower in profile, as well as to ensure that light can be applied evenly to the liquid-crystal panel 2. In order to make the backlight unit 1 lower in profile, the height H1 of the lens 112 needs to be minimized; that is, the lens 112 needs to be thinned as much as possible. However, the reduction in thickness of the lens 112 is likely to cause illuminance variations at the back side 22 of the liquid-crystal panel 2, which may result in lack of uniformity in brightness at the front side 21 of the liquid-crystal panel 2. Especially in a case where a distance between the adjacent LED chips 111a is long, a region between the LED chips 111a arranged adjacent each other at the back side 22 of the liquid-crystal panel 2 is located far away from the LED chip 111a, wherefore the quantity of light applied to that region becomes small, which is likely to cause illuminance (brightness) variations between that region and a region close to the LED chip 111a. In order to ensure that the region located far away from the LED chip 111a can be irradiated with light emitted from the LED chip 111a via the lens 112, it is necessary to increase the diameter L2 of the lens 112 to a certain extent, and thus, in this embodiment, the slimming-down of the backlight unit 1 and uniform application of light to the liquid-crystal panel 2 can be achieved by setting the diameter L2 to be greater than the height H1 in the lens 112.

If the diameter L2 of the lens 112 is set to be smaller than the height H1 of the lens 112, it will be difficult to achieve the slimming-down of the backlight unit and uniform light application, and in addition, in the process of insert molding for forming the lens 112 in alignment with the LED chip 111a, the lens and the LED chip are likely to get out of balance. Furthermore, when the light-emitting section 111 comprising the LED chip 111a, the base support 111b, and the lens 112 formed by means of insert molding is soldered to the printed substrate 12, they are likely to get out of balance, which results in assembly problems.

The top surface 112a of the lens 112 includes a central portion 1121, a first curved portion 1122, and a second curved portion 1123. In the lens 112, the top surface 112a curved so as to provide the central recess comprises a first region where reaching light is reflected for its exit from the side surface 112b, and a second region where reaching light is refracted outward for its exit from the top surface 112a. The first region is formed in the first curved portion 1122, and the second region is formed in the second curved portion 1123.

The central portion 1121 is formed in the center of the top surface 112a opposed to the liquid-crystal panel 2, and the center of the central portion 1121 (viz., the optical axis of the lens 112) is located on the optical axis S of the LED chip 111a. The central portion 1121 is circularly shaped in parallel with the light-emitting surface of the LED chip 111a, and a diameter L3 of the circular shape is set at 1 mm, for example. By way of another embodiment of the invention, instead of the circular shape, the central portion 1121 may be configured to be defined by a lateral surface of a cone having an imaginary circular base, the cone protruding toward the LED chip 111a from the imaginary circular base.

The central portion 1121 is formed to apply light to that region of the diffusion plate 3 acting as an object to be illuminated which faces the central portion 1121. However, since the central portion 1121 is a part opposed to the LED chip 111a, when most of light emitted from the LED chip 111a reaches the central portion 1121 and most part of the reaching light passes directly therethrough, then the illuminance of the region facing the central portion 1121 is significantly increased. With this in view, the shape of the central portion 1121 should preferably be defined by the lateral surface of the cone as described above. In the case where the shape of the central portion is defined by the lateral surface of the cone, most of light is reflected from the central portion 1121, wherefore the quantity of light which passes through the central portion 1121 is decreased, and consequently the illuminance of the region facing the central portion 1121 can be reduced.

The first curved portion 1122 is an annular curved surface which is continuous with an outer edge of the central portion 1121, and extends in one of the directions of the optical axis S of the LED chip 111a (the direction toward the liquid-crystal panel 2) as it extends outward, while being curved in convex form inwardly and in the one optical-axis S direction. The curved surface is designed for total reflection of light emitted from the LED chip 111a.

More specifically, out of light emitted from the LED chip 111a, light which has reached the first curved portion 1122 is totally reflected from the first curved portion 1122, is transmitted through the side surface 112b of the lens, and is directed toward the reflective member 113. Upon reaching the reflective member 113, the light is diffused by the reflective member 113, and is applied to that region of the diffusion plate 3 acting as the to-be-illuminated object which is not opposed to the LED chip 111a. In this way, the quantity of light applied to the region which is not confronted by the LED chip 111a can be increased.

In order to cause total reflection of light emitted from the LED chip 111a, the first curved portion 1122 is so configured that the incident angle of light emitted from the LED chip 111a is greater than or equal to a critical angle φ. For example, given that acrylic resin is used as the material for the lens 112, the refractive index of the acrylic resin is 1.49, whereas the refractive index of air is 1, wherefore the following relationship is obtained: sin φ=1/1.49. A critical angle φ of 42.1° is derived from this relational expression, and correspondingly the first curved portion 1122 is so configured that the incident angle is greater than or equal to 42.1°.

The second curved portion 1123 is an annular curved surface which is continuous with an outer edge of the first curved portion 1122, and extends in the other of the directions along the optical axis S of the LED chip 111a (the direction away from the liquid-crystal panel 2) as it extends outward, while being curved in convex form outwardly and in the one optical-axis S direction. In this embodiment, the lens 112 is disposed so that its bottom abuts against a base portion 1131 of the reflective member 113 that will be described below.

Out of light emitted from the LED chip 111a, light which has reached the second curved portion 1123 is refracted in a direction toward the light-emitting section 111 when passing through the second curved portion 1123 so as to travel toward the diffusion plate 3 and the reflective member 113. Upon reaching the reflective member 113, the light is diffused for travel toward the diffusion plate 3. The light thusly directed toward the diffusion plate 3 by the second curved portion 1123 is mainly applied to a region of the diffusion plate 3 that differs from the region thereof irradiated with light from the central portion 1121 and the first curved portion 1122, which makes up for the insufficiency of light quantity. Note that the second curved portion 1123 is required to allow transmission of light, and is therefore configured so that the incident angle is smaller than 42.1° to avoid total reflection of light emitted from the LED chip 111a.

Thus, in the lens 112, the outer edge of the central portion 1121 is formed with the first curved portion 1122 for totally reflecting light emitted from the LED chip 111a so that the light can be directed toward the side surface 112b of the lens 112, and the outer edge of the first curved portion 1122 is formed with the second curved portion 1123 for refracting light emitted from the LED chip 111a. In general, the LED chip 111a has high directivity, and the quantity of light in the vicinity of the optical axis S is very large, and thus, the quantity of light decreases as the exit angle of light with respect to the optical axis S increases. Accordingly, in order to increase the quantity of light applied to a region located relatively far away from the optical axis S of the LED chip 111a (viz., the optical axis of the lens 112), rather than light having a large exit angle with respect to the optical axis S, light having a small exit angle with respect to the optical axis S needs to be directed toward that region. In this embodiment, as has already been described, since the first curved portion 1122 for totally reflecting light toward that region is formed in contiguous relation around the central portion 1121 through which the optical axis S passes, it is possible to increase the quantity of light applied to that region. By contrast, if the second curved portion 1123 is formed in contiguous relation around the central portion 1121, and the first curved portion 1122 is formed in contiguous relation around the second curved portion 1123, light traveling toward the first curved portion 1122 will exhibit a larger exit angle with respect to the optical axis S, and consequently total reflection occurs at the first curved portion 1122, and thus the quantity of light applied to that region decreases.

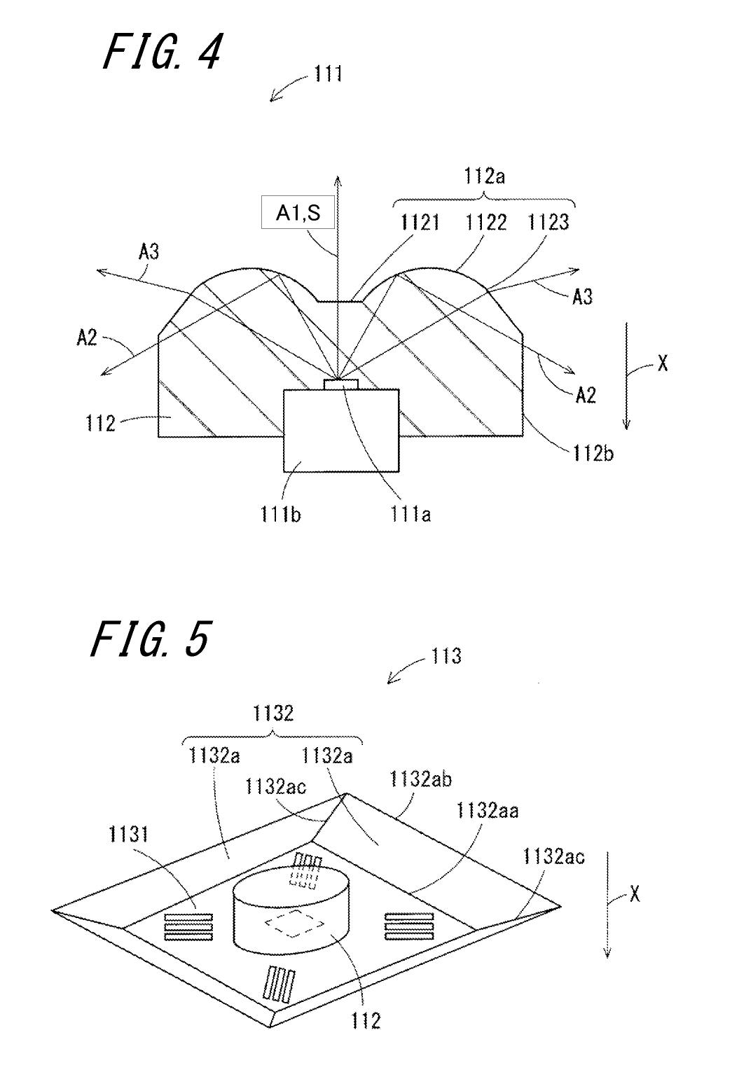

FIG. 4 is a view for explaining the optical path of light emitted from the LED chip 111a. Light emitted from the LED chip 111a enters the lens 112, and is then diffused by the lens 112. Specifically, out of light incident on the lens 112, light which has reached the central portion 1121 at the top surface 112a opposed to the liquid-crystal panel 2 is caused to exit in a direction indicated by arrow A1 toward the liquid-crystal panel 2; light which has reached the first curved portion 1122 is totally reflected therefrom to exit in a direction indicated by arrow A2 from the side surface 112b; and light which has reached the second curved portion 1123 is refracted outward (in a direction away from the LED chip 111a) to exit in a direction indicated by arrow A3 toward the liquid-crystal panel 2.

In this embodiment, the LED chip 111a and the lens 112 are formed in precise alignment with each other so that the lens 112 is placed in contact with the LED chip 111a, with its center (viz., the optical axis of the lens 112) located on the optical axis S of the LED chip 111a. As the technique of forming the LED chip 111a and the lens 112 in alignment in advance, a few ways will be considered, i.e. insert molding, and a method of fitting the LED chip 111a supported on the base support 111b in the lens 112 molded in a predetermined shape. In this embodiment, the LED chip 111a and the lens 112 are formed in alignment with each other in advance by insert molding.

Molds used for insert molding are broadly classified as an upper mold and a lower mold. In the molding process, a resin used as the raw material of the lens 112 is poured, through a resin inlet, into a space created by combining the upper mold and the lower mold, while retaining the LED chip 111a. Alternatively, the molding process may be carried out by pouring a resin used as the raw material of the lens 112 into a space created by combining the upper mold and the lower mold through a resin inlet, while retaining the LED chip 111a supported on the base support 111b. By forming the LED chip 111a and the lens 112 by means of insert molding in that way, it is possible to ensure precise alignment between the lens 112 and the LED chip 111a so that the lens 112 abuts on the LED chip 111a. Thus, the backlight unit 1 becomes capable of reflection and refraction of light emitted from the LED chip 111a with high accuracy by the action of the lens 112 contacted by the LED chip 111a, and accordingly, even in the low-profile liquid-crystal display apparatus 100 in which a distance H3 from the diffusion plate 3 to the printed substrate 12 is short, the liquid-crystal panel 2 can be irradiated with light with uniformity in the brightness of the liquid-crystal panel 2 in the planar direction thereof.

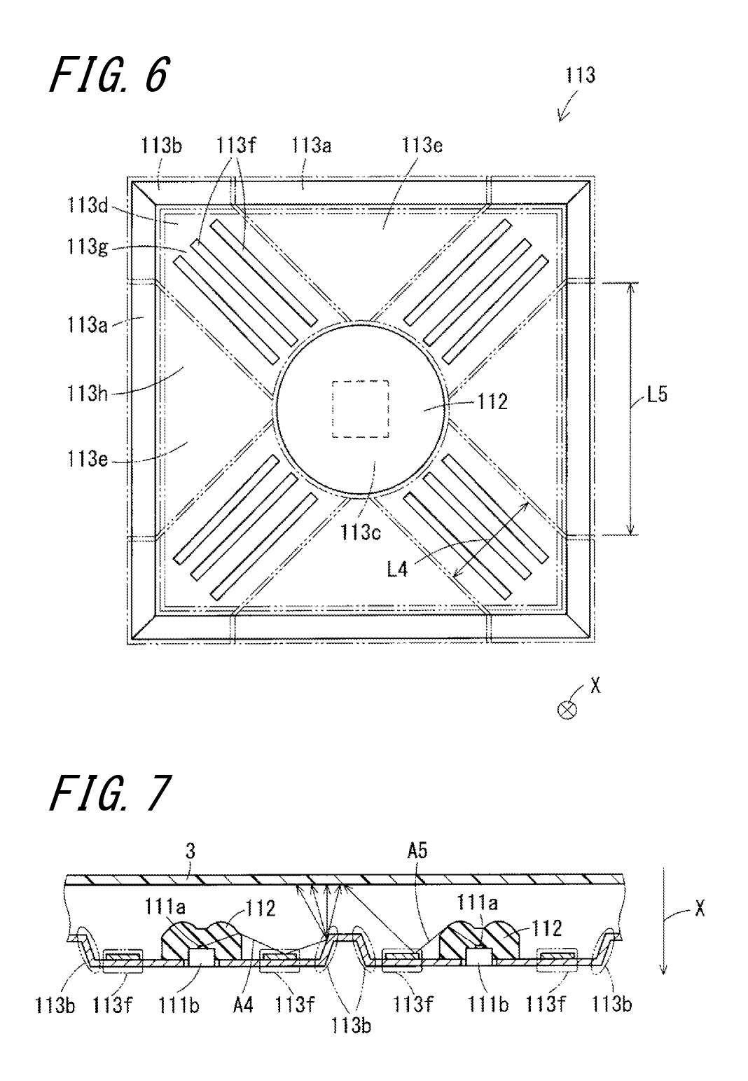

The reflective member 113 will be explained with reference to FIGS. 5 and 6. FIG. 5 is a perspective view of the reflective member 113 and the lens 112, and FIG. 6 is a view showing the reflective member 113 and the lens 112 as viewed in a plan view in the X direction. The reflective member 113 is a member for reflecting incident light toward the liquid-crystal panel 2. The reflective member 113 has a polygonal outer shape, for example, a square outer shape when viewed in a plan view in the X direction. The reflective member 113 comprises: a flat-plate base portion 1131, the shape of which is defined by a square which is 38.8 mm on a side, having a centrally-located opening; and an inclined portion 1132 which surrounds the base portion 1131, and is inclined so as to gradually separate from the printed substrate 12 with decreasing proximity to the LED chip 111a. The reflective member 113 comprising the base portion 1131 and the inclined portion 1132 has the form of an upside-down dome centering on the LED chip 111a.

In this embodiment, the reflective member 113 is configured to have a square outer shape when viewed in a plan view in the X direction, and is also configured linearly symmetrically with respect to the diagonal line of the square shape. Also, the reflective member 113 is configured rotationally symmetrically through 90° about the center point of the square shape.

The base portion 1131 is so configured that each side of a square defining its shape as viewed in a plan view in the X direction becomes parallel to the direction of rows or columns of the matrix arrangement of a plurality of LED chips 111a. Moreover, the base portion 1131 is formed along the printed substrate 12, and has a square opening located in the center thereof as viewed in a plan view in the X direction. The length of one side of the square opening is substantially equal to the length L1 of one side of the base support 111b for supporting the LED chip 111a, so that the base support 111b is inserted through the opening.

The inclined portion 1132 is a collective term for four trapezoidal flat plates 1132a each having a trapezoidal main surface. In each of the trapezoidal flat plates 1132a, of the two opposed bases of the trapezoidal shape, the shorter one, namely a base 1132aa is continuous with each side of the square base portion 1131, and the longer one, namely a base 1132ab lies farther away from the printed substrate 12 than does the base portion 1131 in the X direction. The adjacent trapezoidal flat plates 1132a are continuous with each other at their legs 1132ac.

As shown in FIG. 2A, an angle of inclination θ1 between the trapezoidal flat plate 1132a and the printed substrate 12 is 80°, for example. Moreover, a height H2 of the inclined portion 1132 in the X direction is 3.5 mm, for example.

The base portion 1131 and the inclined portion 1132 are made of high-luminance PET (Polyethylene Terephthalate), aluminum, or the like. The high-luminance PET is foamed PET containing a fluorescent agent, and examples thereof include E60V (product name) manufactured by TORAY Industries, Inc. The base portion 1131 and the inclined portion 1132 have a thickness in a range of 0.1 to 0.5 mm, for example.

As shown in FIG. 6, when viewed in a plan view in the X direction, a region of the inclined portion 1132 corresponding to a corner of the square reflective member 113 will be referred to as a corner part 113b. Moreover, when viewed in a plan view in the X direction, a region of the inclined portion 1132 corresponding to a side of the square reflective member 113, except the corner part 113b, will be referred to as a side 113a. Moreover, when viewed in a plan view in the X direction, a region of the base portion 1131 disposed in overlapping relation to the lens 112 will be referred to as a central part 113c. Moreover, when viewed in a plan view in the X direction, a region of the base portion 1131 located between the corner part 113b and the central part 113c will be referred to as a first reflective region 113d. A width L4 of the first reflective region 113d falls in the range of 10 mm to 25 mm. Moreover, when viewed in a plan view in the X direction, a region of the base portion 1131 located between the side 113a and the central part 113c will be referred to as a second reflective region 113e. A width L5 of the second reflective region 113e falls in the range of 15 mm to 35 mm.

The first reflective region 113d has a specular reflection portion 113f. The specular reflection portion 113f is a part of the reflective member 113 that exhibits a specular reflectivity of greater than or equal to 98% for visible light emitted from the LED chip 111a, and the specular reflection portion 113f is primarily disposed in the first reflective region 113d. The specular reflection portion 113f is formed on the base portion 1131 by means of attachment of a sheet of silver or aluminum, vapor deposition of aluminum, or otherwise. By forming the specular reflection portion 113f of a metal such as silver or aluminum, it is possible to improve dissipation of heat generated from the LED chip 111a.

Alternatively, the reflective member 113 having the specular reflection portion 113f may be formed by molding high-luminance PET or the like using a mold having a mirror-finished portion. In this case, part of the base portion 1131 serves as the specular reflection portion 113f.

In this embodiment, the specular reflectivity of the specular reflection portion 113f is 99%. The specular reflection portion 113f has a total reflectivity in a range of 98% to 100%, for example, for visible light emitted from the LED chip 111a, and, in this embodiment, the total reflectivity is 99%.

As specified in JIS H 0201:1998, the specular reflectivity refers to reflectivity in specular reflection, and its measurement can be conducted by a heretofore known method. Moreover, the total reflectivity refers to the sum of specular reflectivity and diffuse reflectivity, and its measurement can be conducted in conformity to JIS K 7375.

In this embodiment, three specular reflection portions 113f are disposed in the respective first reflective regions 113d so as to be apart from each other. The three specular reflection portions 113f are each formed in a strip-like shape extending from the central part 113c to the corner part 113b. In the three specular reflection portions 113f, the width is 1 mm, the length is 8 mm, and the pitch is 4 mm. Note that the number, width, length, and pitch of the specular reflection portions 113f are not limited to the values as described above.

In the first reflective region 113d, the other area than the specular reflection portions 113f serves as a first diffuse reflection portion 113g which is lower in specular reflectivity than the specular reflection portion 113f. The first diffuse reflection portion 113g has a specular reflectivity in a range of 80% to 98%, and has a total reflectivity in a range of 94% to 98%. In the first reflective region 113d, the total area of the first diffuse reflection portion 113g is 2 to 4 times the total area of the specular reflection portions 113f.

The second reflective region 113e, in its entirety, serves as a second diffuse reflection portion 113h which is lower in specular reflectivity than the specular reflection portion 113f. The second diffuse reflection portion 113h has a specular reflectivity in a range of 80% to 98%. Moreover, the total reflectivity of the second diffuse reflection portion 113h is less than or equal to the total reflectivity of the specular reflection portion 113f, and thus, for example, falls in the range of 94% to 98%. In this embodiment, the specular reflectivity of the second diffuse reflection portion 113h is equal to the specular reflectivity of the first diffuse reflection portion 113g, and the total reflectivity of the second diffuse reflection portion 113h is equal to the total reflectivity of the first diffuse reflection portion 113g.

The side 113a, the corner part 113b, and the central part 113c have a specular reflectivity in a range of 80% to 98%, for example, and has a total reflectivity in a range of 94% to 98%, for example. In this embodiment, the specular reflectivities of the side 113a, the corner part 113b, and the central part 113c are equal to the specular reflectivity of the first diffuse reflection portion 113g, and the total reflectivities of the side 113a, the corner part 113b, and the central part 113c are equal to the total reflectivity of the first diffuse reflection portion 113g.

It is preferable that the thusly constructed reflective members 113 provided in their respective light-emitting devices 11 are integrally molded. As the method of integrally molding a plurality of reflective members 113, where the reflective member 113 is made of foamed PET, extrusion molding can be adopted, and, where the reflective member 113 is made of aluminum, press working can be adopted. By integrally molding the reflective members 113 respectively provided in the plurality of light-emitting sections 111, it is possible to improve the accuracy of placement positions of the plurality of light-emitting sections 111 relative to the printed substrate 12, as well as to reduce the number of process steps required for installation of the reflective members 113 during assembly of the backlight unit 1, with a consequent increase in the efficiency of assembly operation.

Referring to FIGS. 4 and 7, a description will be given below as to the optical path of light emitted from the LED chip 111a in the liquid-crystal display apparatus 100 equipped with the backlight unit 1 thusly constructed. FIG. 7 corresponds to FIG. 2B.

As shown in FIG. 4, in the backlight unit 1, out of light that has been emitted from the LED chip 111a and entered the lens 112, light which has reached the central portion 1121 at the top surface 112a opposed to the liquid-crystal panel 2 is caused to exit in a direction indicated by arrow A1 toward the liquid-crystal panel 2; light which has reached the first curved portion 1122 is reflected therefrom to exit in a direction indicated by arrow A2 from the side surface 112b; and light which has reached the second curved portion 1123 is refracted outward to exit in a direction indicated by arrow A3 toward the liquid-crystal panel 2. The thusly emitted light is isotropically diffused in a planar direction perpendicular to the X direction.

Part of light directed from the central part 113c of the reflective member 113 toward the corner part 113b thereof in the planar direction perpendicular to the X direction travels along an optical path A4 as shown in FIG. 7, is specularly reflected from the specular reflection portion 113f, and reaches the corner part 113b. Upon the light reaching the corner part 113b, diffuse reflection takes place at the corner part 113b, and the light reaches a part of the liquid-crystal panel 2 opposed to the corner part 113b.

Moreover, part of light directed from the central part 113c of the reflective member 113 toward the corner part 113b thereof in the planar direction perpendicular to the X direction travels along an optical path A5 as shown in FIG. 7, is specularly reflected from the specular reflection portion 113f, and reaches the part of the liquid-crystal panel 2 opposed to the corner part 113b.

Thus, in this embodiment, the specular reflection portion 113f is formed in the respective first reflective regions 113d of the reflective member 113, wherefore the quantity of light reaching the part of the liquid-crystal panel 2 opposed to the corner part 113b of the reflective member 113 is increased. This makes it possible to render light applied to the liquid-crystal panel 2 uniform, and thereby allow the liquid-crystal display apparatus 100 to display images of even higher quality.

Moreover, in this embodiment, the reflective member 113 has, in the respective first reflective region 113d, the specular reflection portion 113f and the first diffuse reflection portion 113g which is lower in specular reflectivity than the specular reflection portion 113f. Accordingly, the quantity of light reaching the part of the liquid-crystal panel 2 opposed to the corner part 113b can be increased by specular reflection occurring in the specular reflection portion 113f, and also the quantity of light reaching a part of the liquid-crystal panel 2 opposed to the first reflective region 113d can be maintained at an adequate level by diffuse reflection occurring in the first diffuse reflection portion 113g, wherefore light applied to the liquid-crystal panel 2 can be rendered even more uniform.

Moreover, in this embodiment, the plurality of specular reflection portions 113f are disposed in the respective first reflective regions 113d so as to be apart from each other. Accordingly, diffuse reflection takes place in a region between the specular reflection portions 113f, wherefore light applied to the part of the liquid-crystal panel 2 opposed to the first reflective region 113d can be rendered uniform.

Moreover, in this embodiment, the reflective member 113 has, in the second reflective region 113e, the second diffuse reflection portion 113h which is lower in specular reflectivity than the specular reflection portion 113f. Accordingly, diffuse reflection takes place in the second diffuse reflection portion 113h, wherefore the quantity of light reaching the part of the liquid-crystal panel 2 opposed to the corner part 113b of the reflective member 113 is increased. This makes it possible to render light applied to the liquid-crystal panel 2 even more uniform.

Moreover, in this embodiment, the total reflectivity of the specular reflection portion 113f is greater than or equal to the total reflectivity of the second diffuse reflection portion 113h. Therefore, the specular reflection portion 113f is less prone to transmission and absorption of light emitted from the LED chip 111a than is the second diffuse reflection portion 113h. This makes it possible to increase the quantity of light reaching the part of the liquid-crystal panel 2 opposed to the corner part 113b of the reflective member 113, and thereby render light applied to the liquid-crystal panel 2 even more uniform.

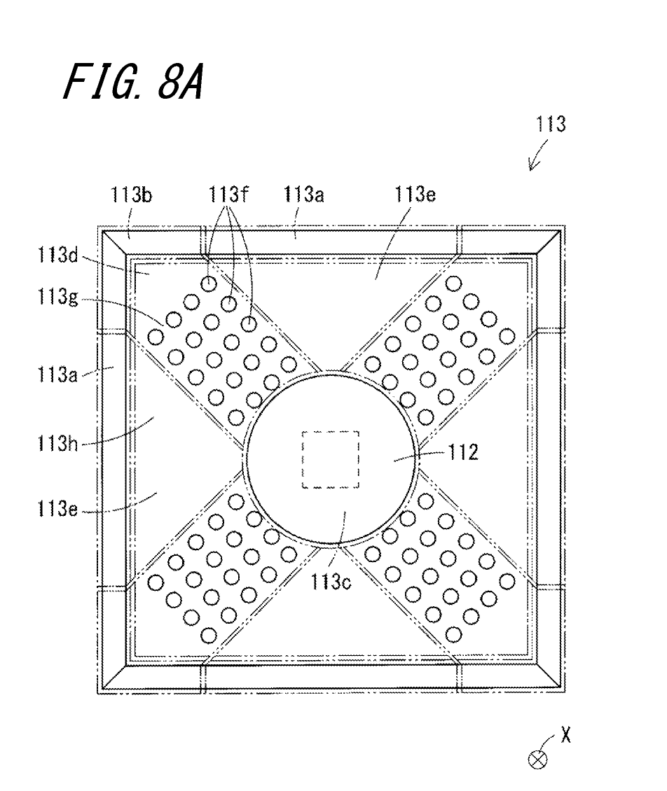

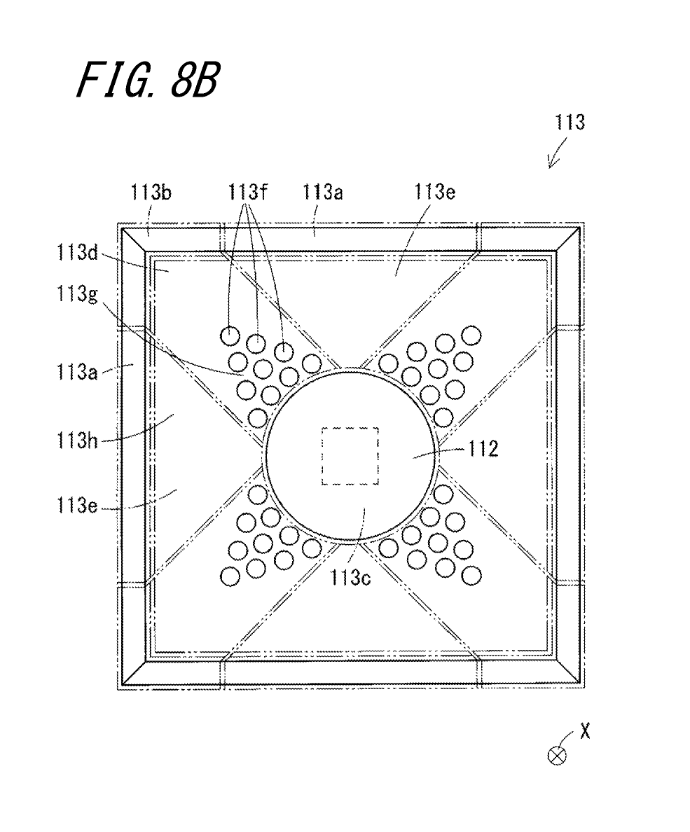

Although, in the above-described embodiment, the specular reflection portion 113f is given the strip-like shape, by way of another embodiment of the invention, the specular reflection portion 113f may be formed in a circular shape. FIGS. 8A and 8B are views showing the reflective member 113 having circular specular reflection portions 113f and the lens 112 as viewed in a plan view in the X direction.

In the example shown in FIG. 8A, in the respective first reflective regions 113d, twenty circular specular reflection portions 113f are spaced apart while being evenly distributed. The diameter of the circular specular reflection portion 113f is 0.8 mm. In the example shown in FIG. 8B, in the respective first reflective regions 113d, ten circular specular reflection portions 113f are spaced apart while being distributed in a manner such that the number of the specular reflection portions 113f decreases gradually in a direction from the central part 113c to the corner part 113b. The diameter of the circular specular reflection portion 113f is 1.0 mm.

In such an embodiment, since the number of regions among the specular reflection portions 113f can be increased, it is possible to ensure uniformity in light reaching that part of the liquid-crystal panel 2 opposed to the first reflective region 113d. Accordingly, it is preferable that the specular reflection portion 113f is given a circular shape rather than a strip-like shape.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### REFERENCE SIGNS LIST

1: Backlight unit
2: Liquid-crystal panel
100: Liquid-crystal display apparatus
111a: LED chip
111b: Base support
112: Lens
113: Reflective member
113a: Side
113b: Corner part
113c: Central part
113d: First reflective region
113e: Second reflective region
113f: Specular reflection portion
113g: First diffuse reflection portion
113h: Second diffuse reflection portion

1. A light-emitting device for illuminating an object to be illuminated, comprising:
a light-emitting section which applies light to a to-be-illuminated object; and
a reflective member disposed around the light-emitting section,
the reflective member being polygonal in outer shape as viewed in a plan view from a to-be-illuminated object side, the reflective member having a specular reflection portion in respective first reflective regions which are regions between corner parts of the reflective member and the light-emitting section as viewed in a plan view from the to-be-illuminated object side,
the light-emitting section being located in a center of the reflective member as viewed in a plan view from the to-be-illuminated object side.

2. The light-emitting device according to claim 1,
wherein the reflective member has, in the respective first reflective regions, a first diffuse reflection portion which is lower in specular reflectivity than the specular reflection portion.

3. The light-emitting device according to claim 1,
wherein the reflective member has, in respective second reflective regions thereof which are regions between sides of the reflective member and the light-emitting section as viewed in a plan view from the to-be-illuminated object side, a second diffuse reflection portion which is lower in specular reflectivity than the specular reflection portion.

4. The light-emitting device according to claim 1,
wherein a total reflectivity of the specular reflection portion is greater than or equal to a total reflectivity of the second diffuse reflection portion.

5. The light-emitting device according to claim 1,
wherein a plurality of the specular reflection portions are disposed in the respective first reflective regions so as to be apart from each other.

6. The light-emitting device according to claim 5,
wherein the specular reflection portion is formed in a circular shape as viewed in a plan view from the to-be-illuminated object side.

7. The light-emitting device according to claim 5,
wherein the specular reflection portion is formed in a strip-like shape extending from the light-emitting section to the corner part as viewed in a plan view from the to-be-illuminated object side.

8. The light-emitting device according to claim 1,
wherein the specular reflection portion is formed of silver or aluminum.

9. A display apparatus comprising:
a display panel; and
an illuminating apparatus including a light-emitting device which applies light to a back side of the display panel,
the light-emitting device being the light-emitting device according to claim 1.
